(19) United States
(12) Patent Application Publication
(10) Pub. No.: US 2017/0328099 A1
(43) Pub. Date: Nov. 16, 2017

(54) POP-UP APPARATUS

(71) Applicant: AISIN SEIKI KABUSHIKI KAISHA, Kariya-shi (JP)

(72) Inventors: Shintaro SUZUKI, Kariya-shi (JP); Tomokazu SEKI, Kariya-shi (JP)

(73) Assignee: AISIN SEIKI KABUSHIKI KAISHA, Kariya-shi (JP)

(21) Appl. No.: 15/526,942

(22) PCT Filed: Sep. 28, 2015
(86) PCT No.: PCT/JP2015/004899

§ 371 Date: May 15, 2017

(30) Foreign Application Priority Data
Nov. 26, 2014 (JP) 2014-238812

(51) Int. Cl. E05C 17/22; E05F 1/10; E05C 17/24; E05C 17/20; B60J 5/04

(52) U.S. Cl. CPC E05C 17/22; E05C 17/24; E05C 17/203; E05F 1/1008; B60J 5/04; E05Y 2900/531

(57) ABSTRACT

The pop-up apparatus for a vehicle door, includes a door check to be fixed to a vehicle door, a check link having one end supported to be supported on a body so as to be turnable, the check link being configured to perform relative movement with respect to the door check between the one end and another end of the check link while being applied with a pushing force by the door check, a push arm, which is arranged on a side closer to the another end of the check link, and is configured to turn about a rotation axis to apply a force so as to cause the relative movement of the check link in a direction in which the vehicle door is opened, a posture arm configured to turn about the rotation axis, and urging means configured to apply an urging force, which enables integral turning of the push arm and the posture arm, to the push arm and the posture arm when the posture arm turns.

### TECHNICAL FIELD

The present invention relates to a pop-up apparatus, which includes a mechanism configured to cancel an external force, for example, when a vehicle door of a vehicle such as a passenger automobile is opened at a slight angle.

### BACKGROUND ART

When a person gets on a vehicle, a person who is going to open a vehicle door cannot use hands in some cases. Further, when there is no sufficient space between the vehicle and an object adjacent to the vehicle under this situation, it is necessary to prevent the vehicle door from being brought into contact with the object. In such a case, in order to prevent the vehicle door from being opened at an unintended opening degree, the vehicle door is supported by hand toward an inner side of the vehicle, and is gently opened so as not to be brought into contact with the object adjacent to the vehicle. Therefore, it is conceivable to provide a device capable of opening the vehicle door at a slight angle (referred to as “pop-up” in Description) as an initial operation for opening the vehicle door so that an edge of the vehicle door can be held when the vehicle door is opened.

FIG. 5 is a view for illustrating a state in which a vehicle door 2 is opened, as viewed from a rear side of the vehicle. Further, FIG. 6A and FIG. 6B are views for illustrating a state in which a vehicle door for a front seat on a right side of the vehicle relative to a traveling direction is opened, as viewed from above the vehicle. In general, the vehicle door 2 is supported on a body 3 so as to be turnable about a turning axis of hinge portions 2a arranged on a front side of the vehicle door 2. As illustrated in FIG. 6A, when an operator of the vehicle door 2 opens the vehicle door 2, the vehicle door 2 is moved so that the vehicle door is shifted by a pop-up amount of a slight distance (Lp), thereby enabling the pop-up of opening the vehicle door 2 at a slight angle. After that, as illustrated in FIG. 6B, the operator of the vehicle door can open the vehicle door normally.

In order to achieve a pop-up apparatus, for example, an automobile door checker disclosed in Patent Literature 1 or an opening-degree regulation device for a vehicle door disclosed in Patent Literature 2 can be used for a part thereof. In none of Patent Literature 1 and Patent Literature 2, a pop-up apparatus for a vehicle door is disclosed. For the automobile door checker of Patent Literature 1, a case arranged to slide relative to the door checker having one end pivotably supported on a body is mounted to a vehicle door. The door checker corresponds to a plate 21 of Patent Literature 2. A check plate 6 of the door checker of Patent Literature 1 corresponds to a check link 57 illustrated in FIG. 7 of this application. Here, the pop-up apparatus can be achieved through arrangement of a mechanism configured to push an end of an automobile door checker, which is arranged on a side opposite to the side pivotably supported on the body, as illustrated in FIG. 7 of this application. Similarly to the door checker disclosed in Patent Literature 1, in a representative example of the pop-up apparatus, one end 57a of the check link 57 having an elongated shape is supported on a body 3 of a vehicle so as to be rotatable. The check link 57 is inserted into a door check case 59 supported on the vehicle door D and has an upper surface and a lower surface pressed by pressing members 58 arranged inside the door check case 59. The door check case 59 is mounted on the vehicle door D. The door check link 57 and the door check case 59 are arranged so as to be movable relative to each other. Further, in Patent Literature 2, the plate 21 is sandwiched between stoppers 22 to regulate the opening degree of the vehicle door.

In the pop-up apparatus, for example, it is conceivable to arrange a rockable pop-up lever 60 as a force applying member, which is not disclosed in Patent Literature 1 and Patent Literature 2, on a side closer to an end portion 57b of the check link 57, being arranged on an opposite side, in a direction in which the check link 57 extends. The pop-up lever 60 applies a force to the end portion 57b of the check link 57. In FIG. 7, the vehicle door D is closed when the vehicle door D is positioned on a side close to the body 3, whereas the vehicle door D is opened when the vehicle door D is moved away from the body 3. Here, the pop-up of the vehicle door D is achieved by turning the another end portion 57b of the check link 57 so as to apply the force (F) by the pop-up lever 60. For example, when the force F is applied to the another end portion 57b of the check link 57 by the turnable pop-up lever 60, the door check case 59 is moved by an inertia force P along the check link 57 relative to the check link 57. The vehicle door D fixed to the door check case 59 is moved toward the another end portion 57b side of the check link 57 by a slight pop-up distance. As a result, the vehicle door D is slightly opened.

### CITATION LIST

### Patent Literature

PTL 1: Japanese Patent Application Laid-Open No. 2003-118369

PTL 2: Japanese Patent Application Laid-Open No. 2008-121196

### SUMMARY OF INVENTION

### Technical Problem

When the force F is applied to the another end portion 57b of the check link 57 by the pop-up lever 60, the pop-up lever 60 is moved to a position indicated by the broken lines in FIG. 7 and brought into a state in which a distance between the end portion 57b of the check link 57 and the pop-up lever 60 is reduced. For the operator of the vehicle door, the pop-up generally functions as an auxiliary operation for opening the vehicle door D. However, for various reasons, it is highly possible that the operator of the vehicle door closes the vehicle door during the pop-up or immediately after the pop-up. When the vehicle door is closed during the pop-up or immediately after the pop-up under a state in which the distance between the end portion 57b of the check link 57 and the pop-up lever 60 is reduced, a large load is applied to the pop-up lever 60 or to the check link 57, with the result that the pop-up lever 60 or the check link 57 may be damaged. Meanwhile, when the pop-up lever 60 or the check link 57 is set flexible by reducing stiffness to prevent the load, the pop-up function itself cannot be achieved because the vehicle door itself has a fairly large weight. Thus, in the pop-up apparatus, it is preferred that an external force generated by closing the vehicle door be cancelled so as not to damage the pop-up lever 60 or the check link 57 while achieving the pop-up function.

### Solution to Problem

According to one embodiment of the present invention, there is provided a pop-up apparatus for a vehicle door, including: a door check configured to be fixed to a vehicle door; a check link having one end to be supported on the vehicle body so as to be turnable, the check link being configured to perform relative movement with respect to the door check between the one end and another end of the check link while being applied with a pushing force by the door check; a push arm, which is arranged on a side closer to the another end of the check link, and is configured to turn about a turning axis to apply a force so as to cause the relative movement of the check link in a direction in which the vehicle door is opened; a posture arm configured to turn about the turning axis relative to the push arm; and an urging portion configured to apply an urging force, which enables integral turning of the push arm and the posture arm, to the push arm and the posture arm when the posture arm turns.

According to another embodiment of the present invention, there is further provided a pop-up apparatus for a vehicle door, which is to be mounted to a vehicle body so as to be rotatable, including: a push arm, which is arranged on a side closer to another end of a check link having one end supported on the vehicle body so as to be turnable, and is configured to turn about a rotation axis of the turning to apply a force so as to cause relative movement of the check link with respect to the vehicle door in a direction in which the vehicle door is opened; a posture arm configured to turn about the turning axis relative to the push arm; and an urging portion configured to apply an urging force, which enables integral turning of the push arm and the posture arm, to the push arm and the posture arm when the posture arm turns, in which the push arm pushes the another end of the check link to cause the relative movement of the check link through the integral turning to pop up the vehicle door.

### Advantageous Effects of Invention

The external force generated by closing the vehicle door, for example, immediately after the pop-up of the vehicle door or during the pop-up can be cancelled so as not to be applied to the check link or the pop-up lever.

### BRIEF DESCRIPTION OF DRAWINGS

FIG. 1 is a view for illustrating a pop-up apparatus including an external-force cancel type pop-up lever according to a first embodiment of the present invention, and for illustrating a state immediately before pop-up, that is, a state in which a vehicle door is closed.

FIG. 2A is a view for illustrating the external-force cancel type pop-up lever of the pop-up apparatus according to the embodiment of the present invention.

FIG. 2B is a view for illustrating the external-force cancel type pop-up lever of the pop-up apparatus according to the embodiment of the present invention, and for illustrating a state in which an external force is applied.

FIG. 2C is a view for illustrating the external-force cancel type pop-up lever of the pop-up apparatus according to the embodiment of the present invention, and for illustrating another urging portion.

FIG. 2D is a view for illustrating the external-force cancel type pop-up lever of the pop-up apparatus according to the embodiment of the present invention, and for illustrating another type of a pop-up lever.

FIG. 3A is a view for illustrating the pop-up apparatus for a vehicle door according to the embodiment of the present invention, and for illustrating a state during a pop-up operation or after the pop-up operation.

FIG. 3B is a view for illustrating an example of a method of driving the pop-up lever in the pop-up apparatus for a vehicle door according to the embodiment of the present invention.

FIG. 3C is a view for illustrating another mode of the method of driving the pop-up lever in the pop-up apparatus for a vehicle door according to the embodiment of the present invention.

FIG. 4 is a view for illustrating the pop-up apparatus for a vehicle door according to the embodiment of the present invention, and for illustrating a state in which an external-force cancel mechanism is operated by closing the vehicle door in a state during the pop-up operation or after the pop-up operation.

FIG. 5 is a view for illustrating a vehicle in a state in which the vehicle door is open, as viewed from a rear side of the vehicle.

FIG. 6A is a view for illustrating a degree of opening of the vehicle door at the time of pop-up of the vehicle door.

FIG. 6B is a view for illustrating a way of opening the vehicle door after the end of pop-up of the vehicle door.

FIG. 7 is a view for illustrating a representative example of the pop-up apparatus.

### DESCRIPTION OF EMBODIMENT

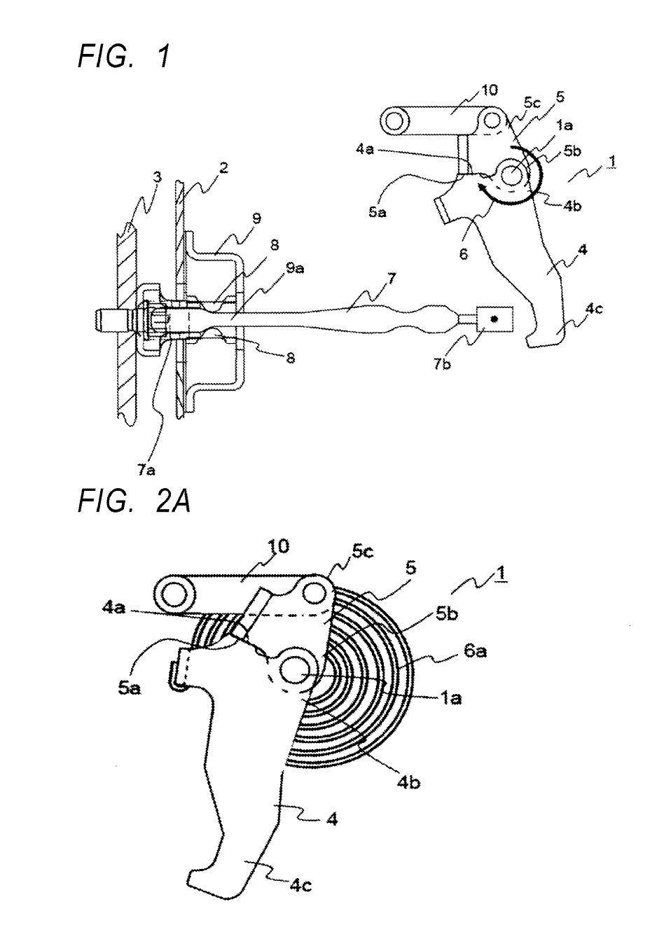

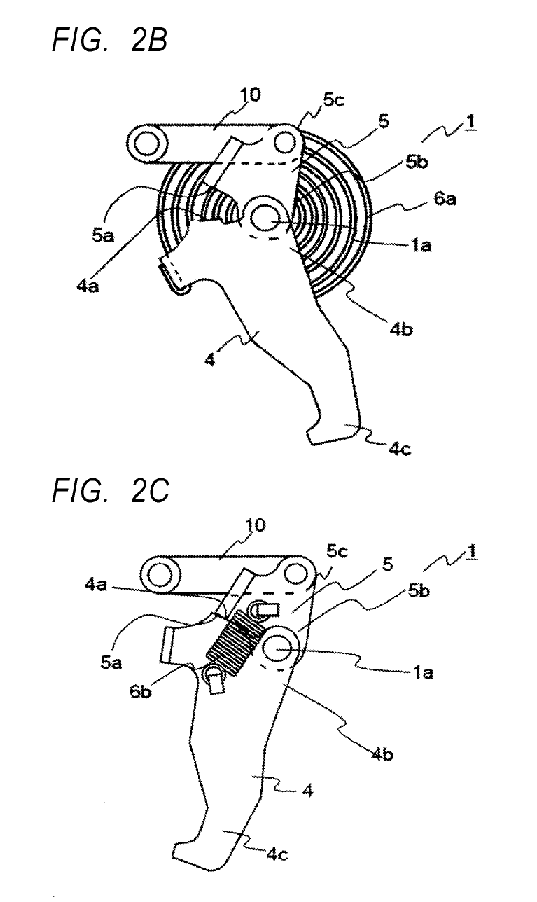

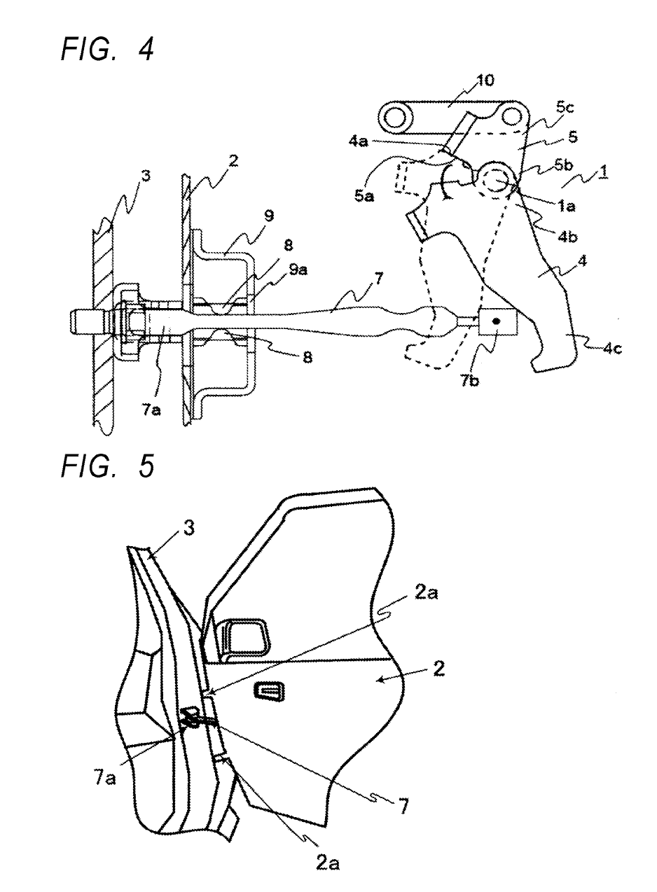

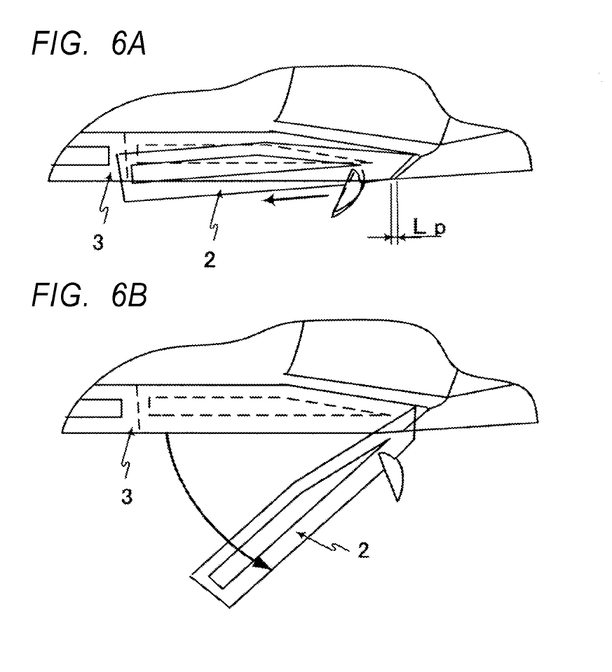

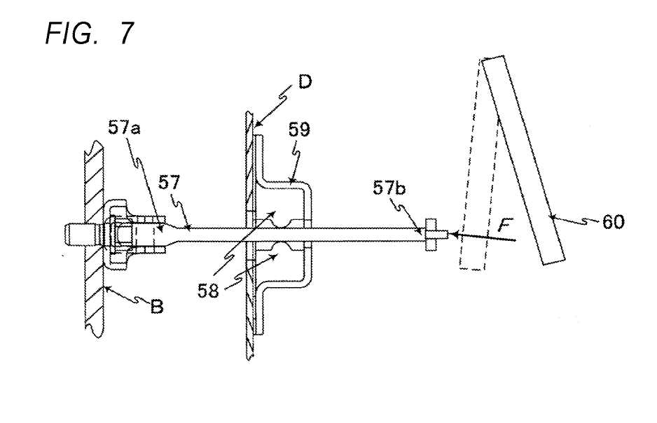

Hereinafter, an external-force cancel type pop-up lever of a pop-up apparatus for a vehicle door 2 according to the present invention is described with reference to FIG. 1, FIG. 2A to FIG. 2D, and FIG. 5. FIG. 1 is a view for illustrating an external-force cancel type pop-up lever 1 of a pop-up apparatus according to a first embodiment of the present invention. FIG. 2A and FIG. 2B are views for illustrating the external-force cancel type pop-up lever as a representative example. FIG. 2C is a modification example of FIG. 2A. As illustrated in FIG. 5, the vehicle door 2 is supported on a body 3 so as to be turnable about a turning axis of hinge portions 2a arranged on a front side of the vehicle door 2, as in the related art. In the vicinity of the hinge portion 2a of the vehicle door 2, a check link 7 is mounted so as to regulate an opening degree of the vehicle door 2. The check link 7 has an elongated shape. One end 7a of the check link 7 is supported on the body 3 so as to be rotatable. Another end 7b of the check link 7 on a side opposite to the one end 7a supported on the body 3 is inserted into the vehicle door 2 through a hole formed in a wall surface of the vehicle door 2 on a side on which the hinge portion 2a of the vehicle door 2 is arranged. On a side of the another end 7b of the check link 7, toward which the check link 7 extends, the external-force cancel type pop-up lever 1 (hereinafter referred to simply as “pop-up lever”) is mounted.

On an inner wall of the vehicle door 2, a door check 9 having a through hole 9a is fixed. The check link 7 is inserted into a through hole 9a of the door check 9 so that the door check 9 is positioned between the one end 7a and the another end 7b of the check link 7. Inside the door check 9, pressing members 8 configured to press surfaces of the check link 7 are arranged. The door check 9 slides while the pressing members 8 are pressing sliding surfaces of the check link 7. Specifically, the door check 9 is movable relative to the check link 7 between the one end 7a and the another end 7b of the check link 7, and the check link 7 is movable relative to the door check 9. One end of the pop-up lever 1 is mounted turnably about a rotation axis 1a including a turning axis.

The pop-up lever 1 includes a push arm 4, a posture arm 5, and an urging portion 6. The push arm 4 is arranged on a side closer to the another end 7b of the check link 7, and is configured to be turned about the rotation axis 1a to apply a force so as to move the check link 7 relative to the door check 9 in a direction in which the vehicle door 2 is opened. The posture arm 5 is turnable about the rotation axis relative to the push arm 4. The push arm 4 and the posture arm 5 are both mounted coaxially to the rotation axis 1a so as to be turnable about the rotation axis 1a. The push arm 4 has a push arm-side restricting portion 4a, and the posture arm 5 has a posture arm-side restricting portion 5a. The push arm-side restricting portion 4a and the posture arm-side restricting portion 5a can come into contact with each other. With the push arm-side restricting portion 4a and the posture arm-side restricting portion 5a, the push arm 4 and the posture arm 5 are prevented from turning about the rotation axis 1a to proceed beyond each other. The urging portion 6 has one end mounted to the push arm 4 and another end mounted to the posture arm 5, and is urged to a side on which the push arm-side restricting portion 4a and the posture arm-side restricting portion 5a come into contact with each other. The urging portion 6 applies an urging force, which enables integral turning of the push arm 4 and the posture arm 5, to the push arm 4 and the posture arm 5 when the posture arm 5 turns. For example, the urging force is applied by the urging portion 6 to the push arm 4 and the posture arm 5 so that the push arm-side restricting portion 4a and the posture arm-side restricting portion 5a come into contact with each other. The urging force which allows the push arm-side restricting portion 4a and the posture arm-side restricting portion 5a to come into contact with each other is applied to the push arm 4 and the posture arm 5. Accordingly, the push arm 4 and the posture arm 5 are moved integrally.

The rotation axis 1a is representatively arranged so as to be positioned on a side of one end 4b of the push arm 4. Another end of the push arm 4, which corresponds to a side opposite to the one end 4b of the push arm 4, functions as a pushing portion 4c configured to push the another end 7b of the check link 7. Meanwhile, even for the posture arm 5, the rotation axis 1a is representatively arranged so as to be positioned on a side of one end 5b of the posture arm 5. Another end 5c on a side opposite to the one end 5b of the posture arm 5 is connected to an end of a crank lever 10 so as to be rotatable.

As indicated by the arrow in FIG. 1, a direction in which the push arm-side restricting portion 4a and the posture arm-side restricting portion 5a are urged by the urging portion 6 so as to come into contact with each other is a direction in which the pushing portion 4c of the pop-up lever 1 approaches the another end 7b of the check link 7 under a state in which the push arm 4 and the posture arm 5 are moved integrally, specifically, are turned integrally. The urging portion 6 is, representatively, a spiral spring 6a as illustrated in FIG. 2A and FIG. 2B. Specifically, for example, a central end portion of the spiral spring 6a as the urging portion 6 is mounted to the posture arm 5 in the vicinity of the rotation axis 1a, and an outer peripheral end portion of the spiral spring is mounted to the push arm 4 so that the push arm-side restricting portion 4a and the posture arm-side restricting portion 5a are urged in a direction of coming into contact with each other. At this time, the urging force for bringing the push arm-side restricting portion 4a and the posture arm-side restricting portion 5a into contact with each other by the urging portion 6 is a force sufficient for the pushing portion 4c of the pop-up lever 1 to push the another end 7b of the check link 7 to enable pop-up of the vehicle door 2. Specifically, the force has such a degree of preventing the pop-up lever 1 from being pushed back by a counter force and thus preventing the push arm-side restricting portion 4a and the posture arm-side restricting portion 5a from being separated from each other when the pop-up lever 1 pushes the another end 7b of the stopped check link 7.

Further, on the contrary, when the another end 7b of the check link 7 pushes the pop-up lever 1 in this state, the urging portion 6 can separate the push arm-side restricting portion 4a and the posture arm-side restricting portion 5a from each other as illustrated in FIG. 2B. The urging portion 6 has an elastic force that allows the push arm-side restricting portion 4a and the posture arm-side restricting portion 5a to return to original positions to come into contact with each other when a pushing force is released. Specifically, the urging portion 6 has the elasticity that enables the push arm 4 to rotate so that the push arm 4 changes an orientation with respect to the posture arm 5, that is, changes an angle of the push arm 4 with respect to the posture arm 5 when the another end 7b of the check link 7 pushes the push arm 4.

As another embodiment, the urging portion 6 is not limited to the spiral spring 6a. Any elastic member may be used as long as the urging force that allows the push arm-side restricting portion 4a and the posture arm-side restricting portion 5a to come into contact with each other can be generated while the push arm-side restricting portion 4a and the posture arm-side restricting portion 5a can be separated from each other when the another end 7b of the check link 7 pushes the pop-up lever 1 reversely. For example, a coiled spring 6b as illustrated in FIG. 2C may be used. Further, in FIG. 2A to FIG. 2C, the push arm-side restricting portion 4a and the posture arm-side restricting portion 5a are arranged on a side closer to the check link 7 with respect to the rotation axis 1a. Here, an example in which the urging force generated by the urging portion 6 acts as the pushing force for bringing the push arm-side restricting portion 4a and the posture arm-side restricting portion 5a into contact with each other is described. However, as illustrated in FIG. 2D, the push arm-side restricting portion 4a and the posture arm-side restricting portion 5a may be arranged on a side opposite to the check link 7 relative to the rotation axis 1a. In this case, the urging force generated by the urging portion 6 acts so that the push arm-side restricting portion 4a and the posture arm-side restricting portion 5a are engaged with each other by a tensile force. As long as a structure is set so that the push arm-side restricting portion 4a and the posture arm-side restricting portion 5a are engaged with each other so that the push arm 4 and the posture arm 5 are moved integrally, specifically, are turned integrally to generate the urging force indicated by the arrow of FIG. 1 in a direction in which the pushing portion 4c of the pop-up lever 1 approaches the another end 7b of the check link 7, it is within the scope of the invention of this application.

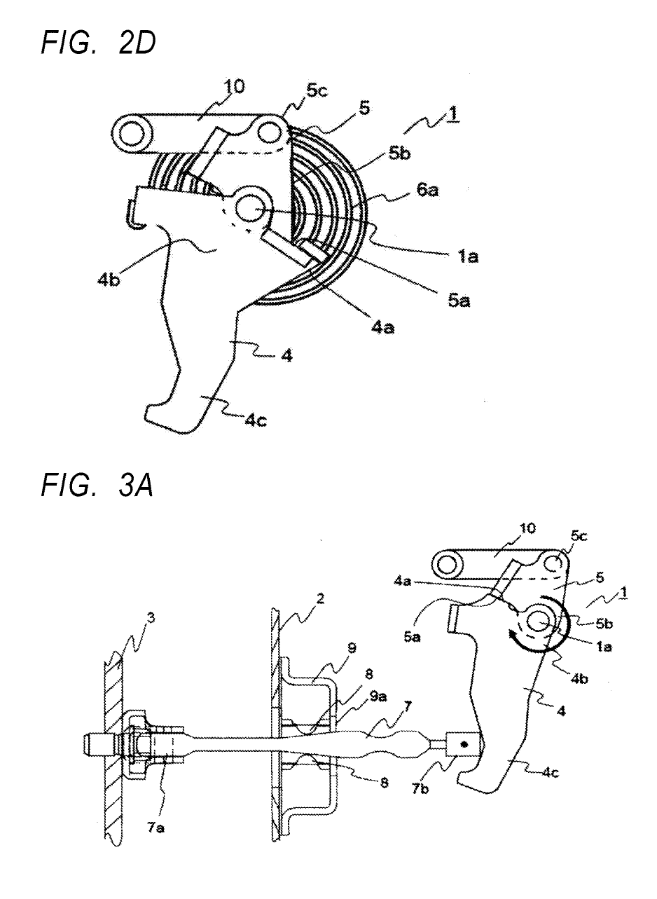

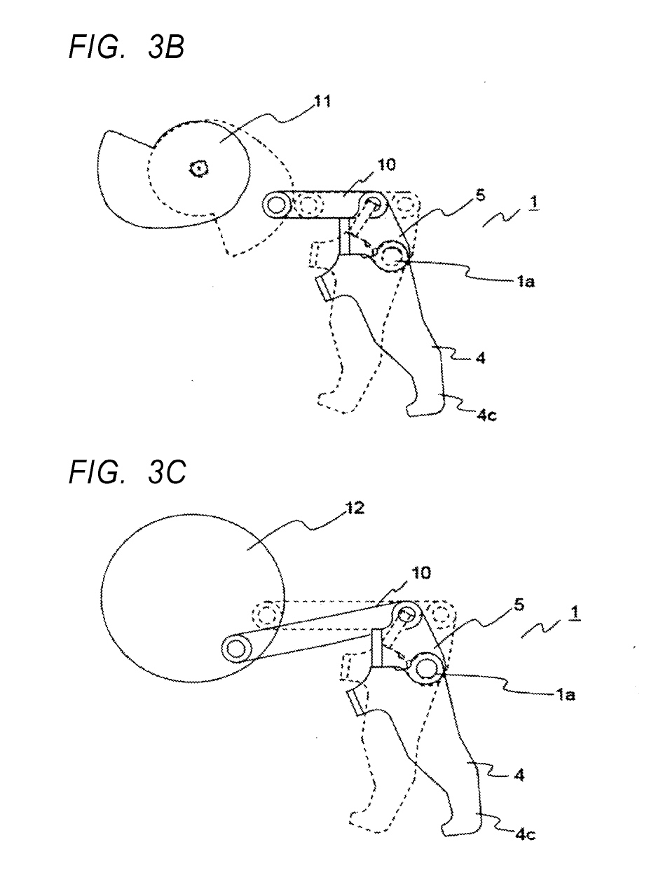

Next, an operation of the external-force cancel type pop-up lever of the present invention is described with reference to FIG. 1, FIG. 3A, and FIG. 4. Here, although the urging portion 6 is not illustrated in FIG. 1, FIG. 3A, and FIG. 4 for simplification of the drawings, the urging portion 6 is mounted as illustrated in FIG. 2A or FIG. 2B. FIG. 1 is a view for illustrating a state before the pop-up, and for illustrating a state in which the vehicle door 2 is closed. The pop-up lever 1 is inclined so that the pushing portion 4c of the pop-up lever 1 is positioned at a location away from the check link 7. In the case of FIG. 1, the crank lever 10 is pulled toward the check link 7. The crank lever 10 may be pushed from a side opposite to the side closer to the check link 7.

Here, as illustrated in FIG. 3A, the crank lever 10 is pushed along the check link so as to turn the posture arm 5 about the rotation axis 1a, thereby inclining the pop-up lever 1. The pushing portion 4c of the pop-up lever 1 pushes the another end 7b of the check link 7 to move the door check 9 relative to the check link 7, with the result that the vehicle door 2 pops up. The check link 7 is moved relative to the door check 9, specifically, is moved with regard to the vehicle door 2, with the result that the vehicle door 2 pops up. In this process, the pop-up lever 1 pushes the another end 7b of the check link 7 without separating the push arm-side restricting portion 4a and the posture arm-side restricting portion 5a from each other. As a method of moving the crank lever 10, various methods are conceivable. For example, as illustrated in FIG. 3B, when a cam 11 may be used so that when the crank lever 10 is in association with a portion of the cam 11 whose radius is small, the crank lever 10 moves toward the door check 9, and when the crank lever 10 is in association with another portion of the cam 11 whose radius is large, the crank lever 10 moves away from the door check 9. Further, as illustrated in FIG. 3C, the crank lever 10 may be pivotably supported directly on a disc plate 12 so as to be rotated. Any setting may be used as long as the crank lever 10 can be moved so that an angle of the posture arm 5 is changed.

The vehicle door 2 is in a popped-up state in a state of FIG. 3A. However, it is conceivable that the operator of the vehicle door 2 closes the vehicle door 2 for some reason. In this case, as illustrated in FIG. 4, the push-arm side restricting portion 4a and the posture arm-side restricting portion 5a are separated from each other. At this time, the urging portion 6 has an elastic force sufficient to restore the urging force for bringing the push arm-side restricting portion 4a and the posture arm-side restricting portion 5a into contact with each other even when the push arm-side restricting portion 4a and the posture arm-side restricting portion 5a are separated from each other in spite of a situation in which the urging force for bringing the push arm-side restricting portion 4a and the posture arm-side restricting portion 5a into contact with each other is applied. After the push arm 4 changes its orientation to the posture arm 5 when the another end 7b of the check link 7 pushes the push arm 4 to separate the another end 7b of the check link 7 and the push arm 4 from each other, the push arm 4 returns to its original position relative to the posture arm 5. Therefore, even when the another end 7b of the check link 7 pushes the pop-up lever 1, the push arm-side restricting portion 4a turns about the rotation axis 1 in a direction opposite to that at the time of pop-up. As a result, the external force generated by closing the vehicle door 2 can be cancelled.

This application claims the benefit of priority from Japanese Patent Application No. 2014-238812, filed on Nov. 26, 2014, the content of which is incorporated herein by reference.

### REFERENCE SIGNS LIST

1 external-force cancel type pop-up lever
1a rotation axis
2 vehicle door
3 body
4 push arm
5 posture arm
6 urging portion
6a spiral spring
6b coiled spring
7 check link
8 pressing member
9 door check

1. A pop-up apparatus for a vehicle door, comprising:
a door check configured to be fixed to a vehicle door;
a check link having one end to be supported on a vehicle body so as to be turnable, the check link being configured to perform relative movement with respect to the door check between the one end and another end of the check link while being applied with a pushing force by the door check;
a push arm, which is arranged on a side closer to the another end of the check link, and is configured to turn about a rotation axis to apply a force so as to cause the relative movement of the check link in a direction in which the vehicle door is opened;
a posture arm configured to turn about the rotation axis relative to the push arm; and
an urging portion configured to apply an urging force, which enables integral turning of the push arm and the posture arm, to the push arm and the posture arm when the posture arm turns,
wherein the push arm is configured to push the another end of the check link through the integral turning to cause the relative movement of the check link so as to pop up the vehicle door.

2. A pop-up apparatus for a vehicle door according to claim 1, wherein the urging portion has one end connected to the posture arm and another end connected to the push arm.

3. A pop-up apparatus for a vehicle door according to claim 1, wherein the urging portion further causes an elastic force that enables the push arm to rotate so as to change an orientation to the posture arm when the another end of the check link pushes the push arm.

4. A pop-up apparatus for a vehicle door according to claim 1,
wherein the push arm has a push arm-side restricting portion, and the posture arm has a posture arm-side restricting portion configured to come into contact with the push arm-side restricting portion, and
wherein the urging portion is configured to apply an urging force, which causes the push arm-side restricting portion and the posture arm-side restricting portion to come into contact or engagement with each other, to the push arm and the posture arm to enable the integral turning.

5. A pop-up apparatus for a vehicle door according to claim 4, wherein, when the push arm changes an orientation to the posture arm, the contact or the engagement between the push arm-side restricting portion and the posture arm-side restricting portion is released.

6. A pop-up apparatus for a vehicle door, which is to be mounted to a vehicle body so as to be rotatable, comprising:
a push arm, which is arranged on a side closer to another end of a check link having one end supported on the vehicle body so as to be turnable, and is configured to turn about a rotation axis to apply a force so as to cause relative movement of the check link with respect to the vehicle door in a direction in which the vehicle door is opened;
a posture arm configured to turn about the rotation axis relative to the push arm; and
an urging portion configured to apply an urging force, which enables integral turning of the push arm and the posture arm, to the push arm and the posture arm when the posture arm turns,
wherein the push arm pushes the another end of the check link to cause the relative movement of the check link through the integral turning to pop up the vehicle door.
